(19) United States
(12) Patent Application Publication
(10) Pub. No.: US 2014/0029305 A1
(43) Pub. Date: Jan. 30, 2014

(54) LIGHT SOURCE MODULE

(71) Applicants: Zhi-Ting Ye, Miaoli County (TW); Ming-Chuan Lin, Taichung City (TW); Kuo-Jui Huang, Taichung City (TW)

(72) Inventors: Zhi-Ting Ye, Miaoli County (TW); Ming-Chuan Lin, Taichung City (TW); Kuo-Jui Huang, Taichung City (TW)

(21) Appl. No.: 13/629,620

(22) Filed: Sep. 28, 2012

Related U.S. Application Data
(60) Provisional application No. 61/675,329, filed on Jul. 25, 2012.

(51) Int. Cl. F21V 8/00

(52) U.S. Cl. 362/619; 362/623; 362/618; 362/621

(57) ABSTRACT

A light source module including a light emitting element and a light guiding element is provided. The light guiding element has a light incident surface, a light emitting surface, a first surface, a second surface, a first reflective layer, and a second reflective layer. The light emitting element faces to the light incident surface. The light incident surface is connected to the light emitting surface. The first surface is connected to the light emitting surface and opposite to the light incident surface. The first surface is non-parallel to the light incident surface. The second surface is connected to the first surface and opposite to the light emitting surface. The first reflective layer is disposed on the first surface. The second reflective layer is disposed on the second surface.

### CROSS-REFERENCE TO RELATED APPLICATION

This application claims the priority benefit of U.S. provisional application Ser. No. 61/675,329, filed on Jul. 25, 2012. The entirety of the above-mentioned patent application is hereby incorporated by reference herein and made a part of this specification.

### BACKGROUND OF THE INVENTION

1. Field of the Invention

The present invention relates to a light source module, and more particularly to a light source module including a reflective layer.

2. Description of Related Art

A conventional illumination device uses a cold-cathode fluorescent lamps (CCFL) as the light emitting element. The CCFL provides a non-directional light source so that the light emitted thereby irradiates toward various directions. Thus, a reflective cover configured beside the CCFL is usually required to reflective the light emitted from the CCFL toward certain irradiation region. Nevertheless, the light reflected by the reflective cover can not be efficiently utilized. In addition, the CCFL is a linear light emitting element so that a plane light source can not be directly achieved by using the CCFL. Therefore, the CCFL is required to be equipped with a light guide plate guiding the light emitted from the CCFL to emit from a surface of the light guide plate so as to achieve a plane light source. However, the uniformity and the light utilization efficiency of such plane light source are often poor.

FIG. 1 schematically illustrates a light source module disclosed in Taiwan Patent No. 1309703. Referring to FIG. 1, in the light source module, the light L provided by the light emitting element 110 is reflective by the oblique side 120a of the light guiding element 120 so as to emit from the light emitting surface So. However, a portion of the light L′ is emitted from the surface outside the light emitting surface So, which causes poor light utilization efficiency of the light source module.

In the application of daily life illumination, the light emitting effect of the light source module is particularly required. For example, the glare effect is one concerned effect. The glare effect is resulted from an unfavorable brightness distribution or an extreme contrast between the object and the background, which causes poor visibility of the object and uncomfortable feeling of the user. Recently, the glare effect can be determined by the Unified Glare Ratio (UGR, as recommended by the CIE). The UGR of the daily life illumination device is commonly requested to be smaller than 19 for the daily life illumination to comply with the specification so that the light source module capable of being applied in the daily life illumination.

### SUMMARY OF THE INVENTION

The invention provides a light source module having desirable light utilization efficiency and light emitting uniformity.

The invention provides another light source module having desirable light utilization efficiency and light emitting uniformity.

The invention is directed to a light source module including a light emitting element and a light guiding element. The light guiding element has a light incident surface, a light emitting surface, a first surface, a second surface, a first reflective layer, and a second reflective layer. The light emitting element faces to the light incident surface. The light incident surface is connected to the light emitting surface. The first surface is connected to the light emitting surface and opposite to the light incident surface. The first surface is non-parallel to the light incident surface. The second surface is connected to the first surface and opposite to the light emitting surface. The first reflective layer is disposed on the first surface. The first reflective layer is disposed on the first surface.

The invention is also directed to another light source module including a light emitting element, a light guiding element and a supporting frame. The light guiding element has a light incident surface, a light emitting surface, a first surface, and a second surface. The light emitting element faces to the light incident surface. The light incident surface is connected to the light emitting surface. The first surface is connected to the light emitting surface and opposite to the light incident surface. The first surface is non-parallel to the light incident surface. The second surface is connected to the first surface and opposite to the light emitting surface. The light emitting element and the light guiding element are accommodated inside the supporting frame. The supporting frame includes a first reflective portion, a second reflective portion, and a third reflective portion. The first reflective portion is parallel to the first surface. The second reflective portion is connected to the first reflective portion and parallel to the second surface. The third reflective portion is connected to the second reflective portion and parallel to the light incident surface.

In light of the foregoing, the light source module according to the invention has the first reflector disposed at the first surface opposite to and non-parallel to the light incident surface so that the emitted light of the light emitting element reflected by the first reflector is mostly emitted from the light emitting surface, which increases light utilization efficiency. In addition, the light source module according to the invention includes the second reflector opposite to the light emitting surface, such that the light provided by the light emitting element can be evenly emitted from the light emitting surface, which enhances the light emitting uniformity of the light source module. In an embodiment of the invention, the light emitting surface of the light guiding element is divided into several sections which facilitate the light to emit from the light guiding element at where is far from the light incident surface. Thereby, the light emitting efficiency of the light source module can be enhanced. In some embodiments, a portion of the body of the light guiding element away from the light incident surface can be configured with a plurality of microstructures capable of reducing the uneven brightness effect of the light source module. Furthermore, two optical films can be arranged in front of the light guiding element. The light emitted from the light guiding element can be subjected to the effect of the optical films so as to achieve desirable light emitting quality. Particularly, the light emitting effect of the light source module can be complied with the required anti-glare specification when the light source module is applied in the illumination application.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 schematically illustrates a conventional light source module.

FIG. 2 is a schematic view of a light source module according to the first embodiment of the invention.

FIG. 3 is a schematic view of a light source module according to the second embodiment of the invention.

FIG. 4 is a schematic view of a light source module according to the third embodiment of the invention.

FIG. 5 is a schematic view of a light source module according to the fourth embodiment of the invention.

FIG. 6 is a schematic view of a light source module according to the fifth embodiment of the invention.

FIG. 7 is a schematic view of a light source module according to the sixth embodiment of the invention.

FIG. 8 is a schematic view of a light source module according to the seventh embodiment of the invention.

FIG. 9 is a schematic view of a light source module according to the eighth embodiment of the invention.

FIG. 10 is a schematic view of a light source module according to the ninth embodiment of the invention.

FIG. 11 is a schematic view of a light source module according to the tenth embodiment of the invention.

FIG. 12 is a schematic view showing the first optical film and the second optical film of the light source module of FIG. 11.

FIG. 13 is a schematic view of a light source module according to the eleventh embodiment of the invention.

FIG. 14 is a schematic view of a light source module according to the twelfth embodiment of the invention.

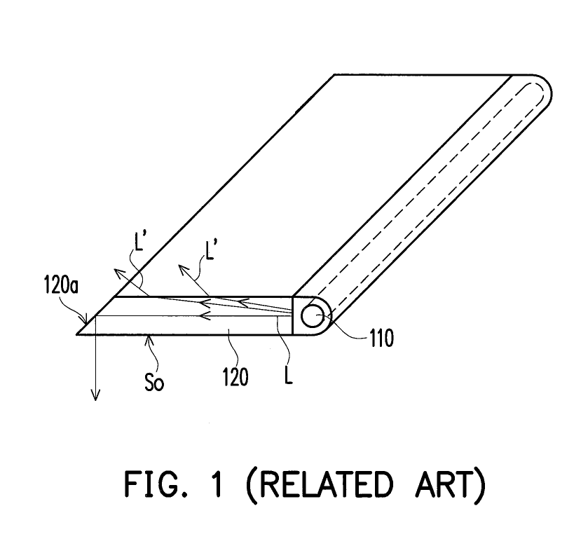

### DETAILED DESCRIPTION OF DISCLOSED EMBODIMENTS

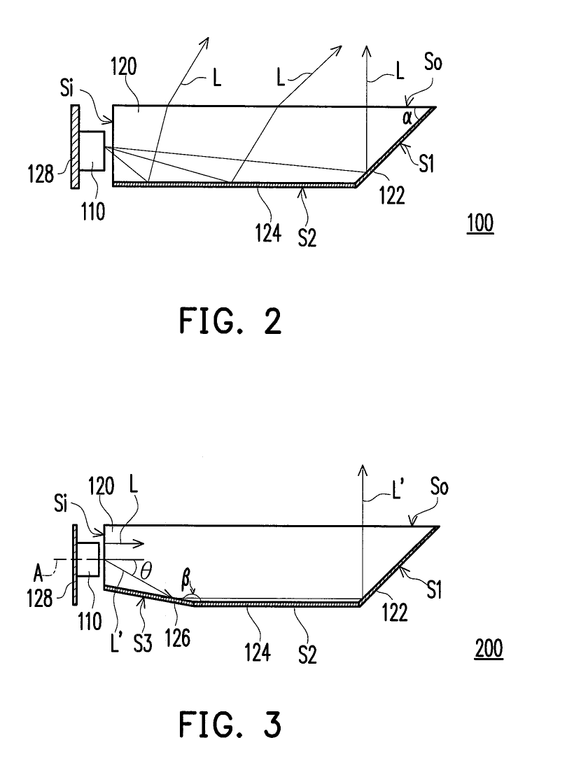

FIG. 2 is a schematic cross-sectional view of a light source module according to the first embodiment of the invention. Referring to FIG. 2, the light source module 100 according to the present embodiment includes a light emitting element 110, a light guiding element 120, a reflective layer 122 and a reflective layer 124. In the present embodiment, the light emitting element 110 can, for example, be a light emitting diode (LED). However, the invention is not limited thereto. In an alternate embodiment, the CCFL or other light emitting element can replace the LED as the light emitting element 110 of the present embodiment.

The light guiding element 120 has a light incident surface Si, a light emitting surface So, a first surface S1, and a second surface S2. The light emitting element 110 faces to the light incident surface Si. The light emitting surface So is connected to the light incident surface Si. The first surface S1 is connected to the light emitting surface So and opposite to the light incident surface Si while the first surface S1 is non-parallel to the light incident surface Si. The second surface S2 is connected to the first surface S1 and opposite to the light emitting surface So. The reflective layer 122 is disposed on the first surface S1. The reflective layer 124 is disposed on the second surface S2. According to the present embodiment, the material of the light guiding element 120 can be, for example, polymethyl methacrylate (PMMA), polycarbonate (PC), or glass, but is not limited in the invention.

It is noted that the first surface S1 is non-parallel to the light incident surface Si in the present embodiment. Accordingly, the light L emitted from the light emitting element 110 and subsequently entering the light guiding element 120 is reflected by the reflective layer 122 on the first surface S1 to travel to the light emitting surface So and emit from the light emitting surface So. In other words, the reflective layer 122 is conducive to introduce the light L emitted from the light emitting element 110 to emit from the light emitting surface So so as to improve the light utilization efficiency.

Furthermore, the first surface S1 and the light emitting surface So are included in an acute angle α. In the present embodiment, the acute angle α is from 30° to 60°. By disposing the reflective layer 122 on the first surface S1 intersecting the light emitting surface So by an acute angle α, the light L irradiating on the reflective layer 122 can be reflected to travel to the light emitting surface So so that the light L provided by the light emitting element 110 can emit out from the light emitting surface So with higher probability. According to the present embodiment, the reflective layer 122 can be a white reflective layer. In addition, the second reflective layer 124 on the second surface S2 can reflect the light L of various incident angles so that the light L can emit out at various angles from the light emitting surface So, which is conducive to enhance the light emitting uniformity of the light source module 100. According to the present embodiment, the reflective layer 124 can also be a white reflective layer.

The light source module 100 of the present embodiment can further include a reflective layer 128 disposed at a side of the light emitting element 110 opposite to the light incident surface Si. The reflective layer 128 can reflect the light L emitted from the light emitting element 110 to the light incident surface Si so that most of the light L can enter the light guiding element 120 to improve the light utilization efficiency of the light source module 100. According to the present embodiment, the reflective layer 128 can be a white reflective layer.

FIG. 3 is a schematic view of a light source module according to the second embodiment of the invention. Referring to FIG. 3, the light source module 200 has a design mainly similar to that of the light source module 100. In the present embodiment, the light guiding element 120 is formed by mold-extrusion process. The light guiding element 120 is not liable to have a V-cut light incident structures on the light incident surface Si for enhancing the light uniformity when the V-cut light incident structure substantially extends in a direction perpendicular to the extrusion direction of the mold-extrusion process. Therefore, the light guiding element 120 of the light source module 200 can further include a third surface S2 connected between the light incident surface S1 and the second surface S2 and an obtuse angle β is included by the third surface S3 and the second surface S2. The obtuse angle β can be from 165° to 170°. In other words, the third surface S3 is a slightly inclined surface configured adjacent to the light incident surface Si.

The light L emitted from the light emitting element 110 mainly emit along the light axis A. However, a portion of the light L′ emits at a direction diverged from the light axis A. The portion of light L′ emitting at a larger angle θ irradiates on the third surface S3. The third surface S3 is a slightly inclined surface, the portion of light L′ could be reflected at the third surface S3 through the total reflection effect and thus emits out from the light guiding element 120 at a position farther from the light incident surface Si. Accordingly, in the light source module 200 of the present embodiment, the third surface S3 is conducive to introduce the portion of the light L′ to emit out from the light guiding element 120 at where is farther from the light incident surface Si, which improves the light emitting uniformity of the light source module 200. It is noted that a reflective layer 126 can be selectively disposed on the third surface S3. According to the present embodiment, the reflective layer 128 can be a white reflective layer.

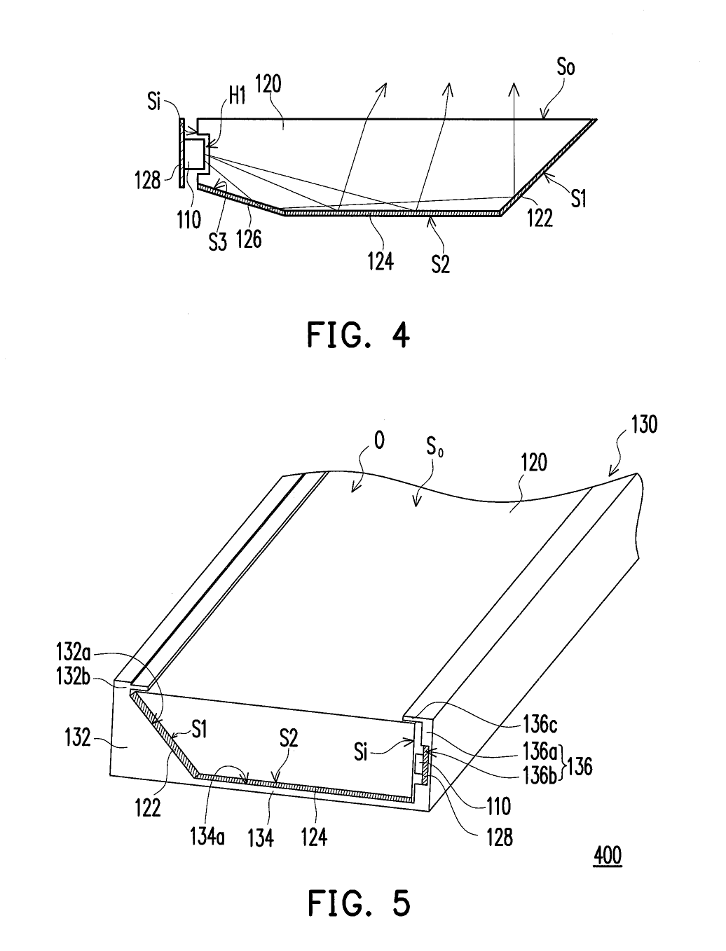

FIG. 4 is a schematic view of a light source module according to the third embodiment of the invention. Referring to FIG. 4, the light source module 300 has a design mainly similar to that of the light source module 200. Nevertheless, in the light source module 300 of the present embodiment, the light incident surface Si can selectively have a first concave H1 suitable for accommodating the light emitting element 110. The light emitting element 110 is accommodated in the first concave H1 of the light incident surface Si so that the light L emitted from the light emitting element 110 is efficiently introduced into the light guiding element 120 from the light incident surface Si.

FIG. 5 is a schematic view of a light source module according to the fourth embodiment of the invention. Referring to FIG. 5, the light source module 500 has a design mainly similar to that of the light source module 100 in the first embodiment. However, the light source module 400 in the present embodiment further includes a supporting frame 130, wherein the light emitting element 110 and the light guiding element 120 are accommodated in the supporting frame 130 and the supporting frame 130 has an opening O exposing the light emitting surface So of the light guiding element 120. In the present embodiment, the reflective layer 122 and the reflective layer 124 are disposed between the supporting frame 130 and the light guiding element 120. Specifically, the supporting frame 130 can include a first portion 132, a second portion 134 and a third portion 136. The inner surface 132a of the first portion 132 is parallel to the first surface S1 of the light guiding element 120 and the reflective layer 122 is disposed between the first surface S1 and the inner surface 132a of the first portion 132. The second portion 134 is connected to the first portion 132. The inner surface 134a of the second portion 134 can be parallel to the second surface S2 of the light guiding element 120 and the reflective layer 124 is disposed between the second surface S2 and the inner surface 134a of the second portion 134. The third portion 136 is connected to the second portion 134. An inner surface 136a of the third portion 136 adjacent to the light guiding element 120 is configured with an concave 136b, wherein the light emitting element 110 and the reflective layer 128 are accommodated in the concave 136b.

Furthermore, the supporting frame 130 can further include a first top portion 132b connected to the first portion 132 and the first top portion 132b covers a portion of the light emitting surface So of the light guiding element 120. The supporting frame 130 can further include a second top portion 136c connected to the third portion 136 and the second top portion 136c covers another portion of the light emitting surface So of the light guiding element 120. The first top portion 132b and the second top portion 136c can firmly fix the light guiding element 120 inside the opening O of the supporting frame 130.

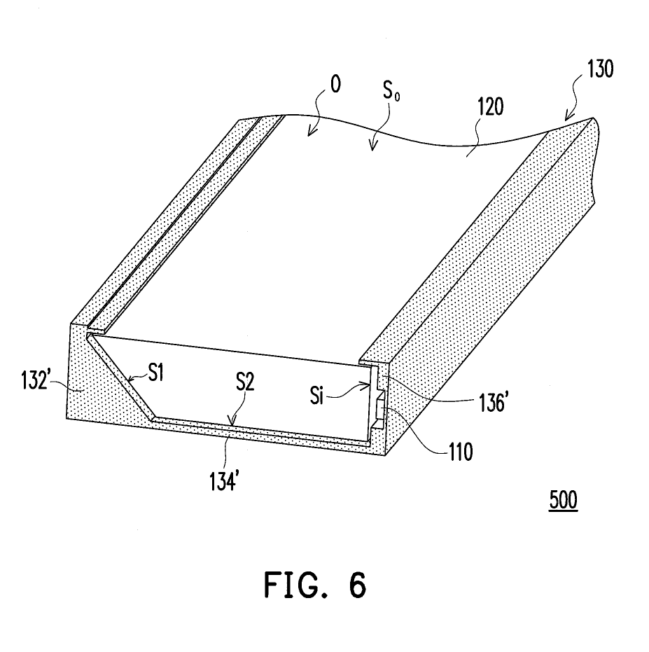

FIG. 6 is a schematic view of a light source module according to the fifth embodiment of the invention. Referring to FIG. 6, the light source module 500 according to the present embodiment includes a light emitting element 110, a light guiding element 120, and a supporting frame 130. The light guiding element 120 has a light incident surface Si, a light emitting surface So, a first surface S1, and a second surface S2. The light emitting element 110 faces to the light incident surface Si. The light emitting surface So is connected to the light incident surface Si. The first surface S1 is connected to the light emitting surface So and opposite to the light incident surface Si. The first surface S1 is non-parallel to the light incident surface Si. The second surface S2 is connected to the first surface S1 and opposite to the light emitting surface So. The light emitting element 110 and the light guiding element 120 are accommodated by the supporting frame 130 while the supporting frame 130 has an opening O exposing the light emitting surface So of the light guiding element 120.

The supporting frame 130 includes a first reflective portion 132′, a second reflective portion 134′, and a third reflective portion 136′. The first reflective portion 132′ is parallel to the first surface 51. The second reflective portion 134′ is connected to the first reflective portion 132′ and parallel to the second surface S2. The third reflective portion 136′ is connected to the second reflective portion 134′ and parallel to the light incident surface Si. In addition to accommodating the light emitting element 110 and the light guiding element 120, the supporting frame 130 has the reflective function to reflect the light L emitted from the light emitting element 110. The first reflective portion 132′ in the present embodiment has the reflective function similar to that of the reflective layer 122 in the first embodiment. The second reflective portion 134′ in the present embodiment has the reflective function similar to that of the reflective layer 124 in the first embodiment. The third reflective portion 136′ in the present embodiment has the reflective function similar to that of the reflective layer 128 in the first embodiment. In other words, the supporting frame 130 of the present embodiment has the function provided by the reflective layers 122, 124, and 128 in the first embodiment so that the structure of the light source module 500 is much simplified and the light source module 500 can have desirable light utilization efficiency and light emitting uniformity.

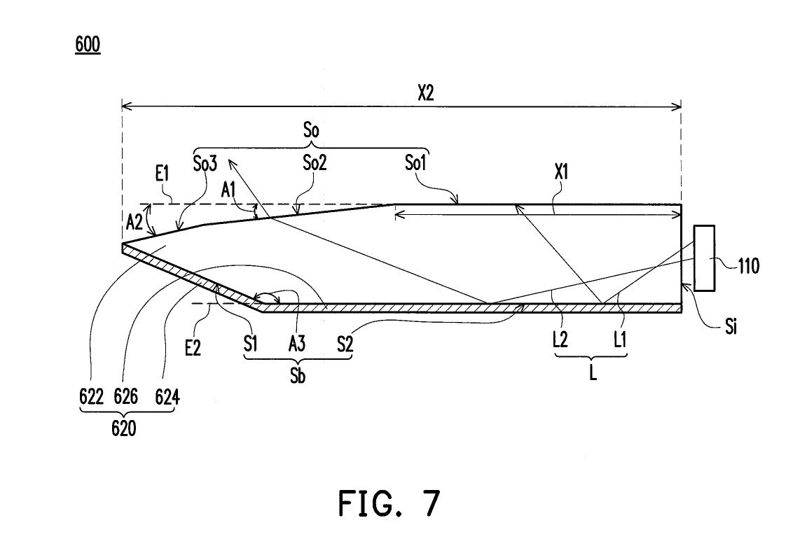

FIG. 7 is a schematic view of a light source module according to the sixth embodiment of the invention. Referring to FIG. 7, a light source module 600 includes a light emitting element 110 and a light guiding element 620. In the present embodiment, the light emitting element 110 can be a lamp providing a linear light source or a point light emitting element, in which the point light emitting element can be a light emitting diode. It is noted that the irradiation region of the linear light emitting element and the point light emitting element is usually restricted, which fails to satisfy the daily life illumination application. Accordingly, the embodiment provides a design which utilizes the light guiding effect of the light guiding element 620 to emit the light in a planar manner so that the required effect, such as the planar light source, can be achieved.

In specific, the light guiding element 620 in the present embodiment includes a body 622, a first reflective layer 624 and a second reflective surface 626. The body 622 has a light incident surface Si, a light emitting surface So, a first surface S1 and a second surface S2. The light emitting element 110 is located beside the light incident surface Si and faces the light incident surface Si. In addition, the second surface S2 is configured between the first surface S1 and the light incident surface Si. The first reflective layer 624 is disposed on the first surface S1 and the second reflective layer 626 is disposed on the second surface S2. The first reflective layer 624 and the second reflective layer 626 can be respectively a white reflective layer or other reflector having light reflecting function such as a mirror reflector. In the embodiment, the first surface S1 and the second surface S2 are connected to each other so as to define a back surface Sb, wherein the light incident surface Si is connected between the back surface Sb and the light emitting surface So.

The light emitting surface So can be divided into three sections including the first section So1, the second section So2, and the third section So3 sequentially arranged outward from light incident surface Si. Herein, the first section So1, the second section So2 and the third section So3 are not parallel to one another.

In the present embodiment, the first section So1 of the light emitting surface So is substantially parallel to the second surface S2, the second section So2 is inclined toward the second surface S2 from the extension E1 of the first section So1 by a first acute angle A1, and the third section So3 is inclined toward the second surface S2 from the extension E1 of the first section So1 by a second acute angle A2. In other words, the configurations of the first section So1, the second section So2 and the third section So3 make the thickness of the body 622 of the light guiding element 620 gradually reduced outward from the light incident surface Si.

The light L emitted from the light emitting element 110 is incident to the light guiding element 620 and can subsequently be reflected by the first reflective layer 624 and the second reflective layer 626 so as to be transmitted to the light emitting surface So, in which the light L1 and the light L2 are respectively transmitted toward the first section So1 and the second section So2 of the light emitting surface So. As such, the length of the light L2 transmitted in the body 622 is larger than the length of the light L1 transmitted in the body 622 and thus the energy loss of the light L2 is more than that of the light L1. In the present embodiment, the second section So2 is conducive to reduce the inner total reflection at the second section So2 such that the light L2 is mostly or completely emitted from the light emitting surface So. The first section So1 and the second section So2 can have approximately brightness.

In addition, the length of the light L traveling to the third section So3 is further longer than the length of the light L2 traveling to the second section So2. Accordingly, the acute angle A2 of the third section So3 is greater than the acute angle A1. The third section So3 is conducive to reduce the inner total reflection at the third section So3 such that the light L is mostly or completely emitted from the third section So3. In the embodiment, the first acute angle A1 can be greater than 0 degree and smaller than 5 degrees and the second acute angle A2 can be from 6 degrees to 10 degrees. It is noted that the abovementioned values are exemplarily depicted and are not intent to limit the invention. In addition, the three sections of the light emitting surface So are only taken as an example of the invention, and the invention is not limited thereto. In an alternate embodiment, the light emitting surface So can be divided into more than three sections and the sections are gradually inclined toward the back surface Sb from the light incident surface Si.

In an optical simulation, two light source modules are simulated, wherein one has the light guiding element with a flat light emitting surface and the other has the light guiding element with the light emitting surface divided into a plurality of sections as depicted in the present embodiment. It is found that the one having the light guiding element with the flat light emitting surface can achieve the light emitting efficiency of about 74% and the other having the light guiding element with the light emitting surface divided into multiple sections can achieve the light emitting efficiency of about 82%. According to the present embodiment, the light emitting surface So of the light guiding element 620 consisted of the first section So1, the second section So2 and the third section So3 can have higher light emitting efficiency and better light emitting uniformity than the design having a flat light emitting surface.

In the present embodiment, the light L from the light emitting element 110 enters the light guiding element 620 at the light incident surface Si. Thereafter, the light L is reflected to the light emitting surface So via the first reflective layer 624 disposed on the first surface 51 and is emitted from the light emitting surface So. Herein, the first surface S1 is an oblique surface opposite to the light incident surface Si so that the first reflective layer 624 can efficiently reflect the light L from the light emitting element 110 to emit from the light emitting surface So, which enhances the light utilizing efficiency of the light source module 600. Regarding to the present embodiment, the first surface 51 is inclined toward the light emitting surface So from the extension E2 of the second surface S2 by an obtuse angle A3 included between the first surface S1 and the second surface S2 wherein the obtuse angle A3 can be from 130 degrees to 140 degrees. It is noted that the above values are merely exemplarily described and are not construed as a limit of the invention.

In specific, the length X1 of the first section So1 of the light emitting surface So which is measured outward from the light incident surface Si is at least greater than a half of the total length X2 of the body 622 of the light guiding element 620 which is measured outward from the light incident surface Si. In addition, the light incident surface Si can selectively have a concave capable of accommodating the light emitting element 110 in an alternate embodiment, which is similar to the design of FIG. 4.

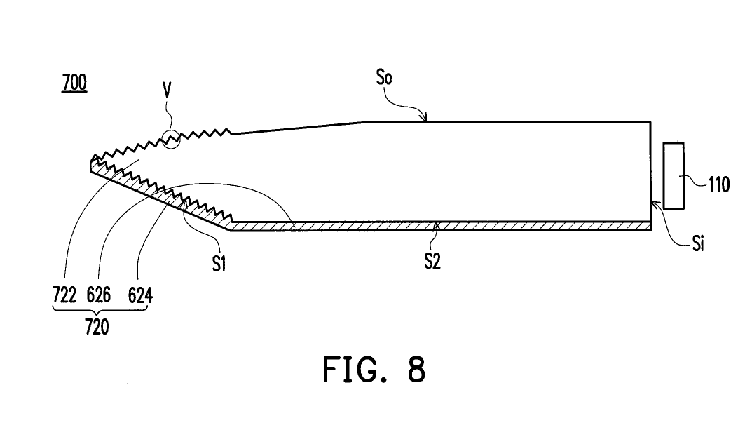

FIG. 8 is a schematic view of a light source module according to the seventh embodiment of the invention. Referring to FIG. 8, a light source module 700 has the design similar to the light source module 600, and thus the same or the like reference number denoted in the present embodiment and the previous embodiment can be referred as the same or the like element and is not reiterated. Specifically, the light source module 700 includes the light emitting element 110 and the light guiding element 720, wherein the light guiding element 720 includes a body 722, the first reflective layer 624 and the second reflective layer 626. According to the embodiment, the body 720 differs from the body 620 mainly in that a plurality of microstructures V are located at the first surface S1 of the body 720 and at a portion of the light emitting surface So corresponding to the first surface S 1. The arrangement of the microstructures V facilitates to refract the incident light into variant angles so that uniformed light emitting effect and desirable light emitting quality of the light source module 700 can be achieved. In one embodiment, the microstructures V can be zigzag structures, wavy structures, island-like structures, or other microstructures for constructing a rough surface.

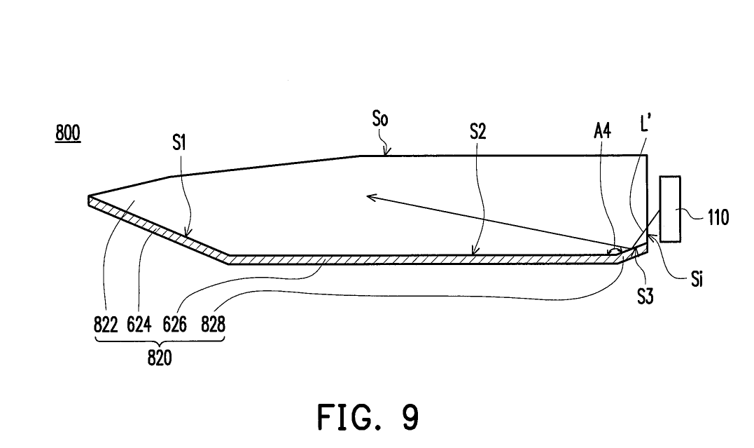

FIG. 9 is a schematic view of a light source module according to the eighth embodiment of the invention. Referring to FIG. 9, a light source module 800 includes a light emitting element 110 and a light guiding element 820, wherein the light emitting element 110 can be referred to the above embodiments and is not repeated. In the present embodiment, the light guiding element 820 includes the body 822, the first reflective layer 624, the second reflective layer 626 and a third reflective layer 828. The body 822 has the first surface S1, the second surface S2, a third surface S3, the light incident surface Si, and the light emitting surface So. Herein, the light incident surface Si and the light emitting surface So can be referred to the above embodiments. In the present embodiment, the body 822 has a third surface S3 connected between the light incident surface Si and the second surface S2 and the third reflective layer 828 is disposed on the third surface S3, which is similar to the design of FIG. 3. The third surface S3 is substantially included with the second surface S2 by an obtuse angle A4. In the embodiment, the obtuse angle A4 can be from 165 degrees to 170 degrees. The slightly oblique third surface S3 facilitates to guide a portion of the light, i.e. the light L′, to emit from the light guiding element 820 at where is far from the light incident surface Si so that the light emitting uniformity of the light source module 800 is improved.

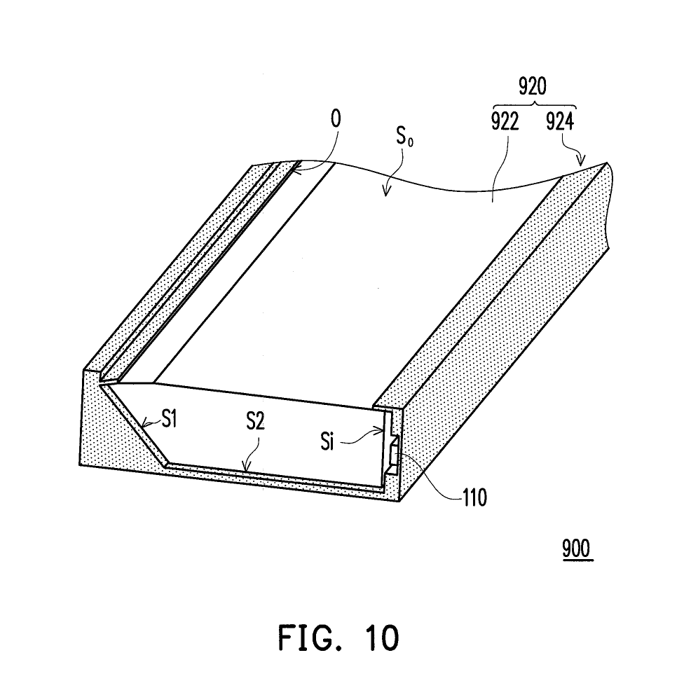

In the above embodiments, the first reflective layer 622, the second reflective layer 624 and the third reflective layer 828 can selectively be a white reflective layer, respectively, or made of reflective material. For example, FIG. 10 is a schematic view of a light source module according to the ninth embodiment of the invention. Referring to FIG. 10, a light source module 900 includes the light emitting element 110 and a light guiding element 920, wherein the light guiding element 920 can include a body 922 and a house 924. The light emitting element 110 and the body 922 are disposed inside the house 924. In the present embodiment, the body 922 of the light guiding element 920 can be selected from any of the aforesaid bodies 622, 722 and 822. In addition, the house 924 can be made of a reflective material and have a light emitting opening O. Herein, the house 924 can be served as the reflector disposed on the surface of the body 922 and the light emitting opening O exposes the light emitting surface So. The material of the body 922 can be selected from polymethyl methacrylate (PMMA), polycarbonate (PC), glass, or other materials having light guiding property.

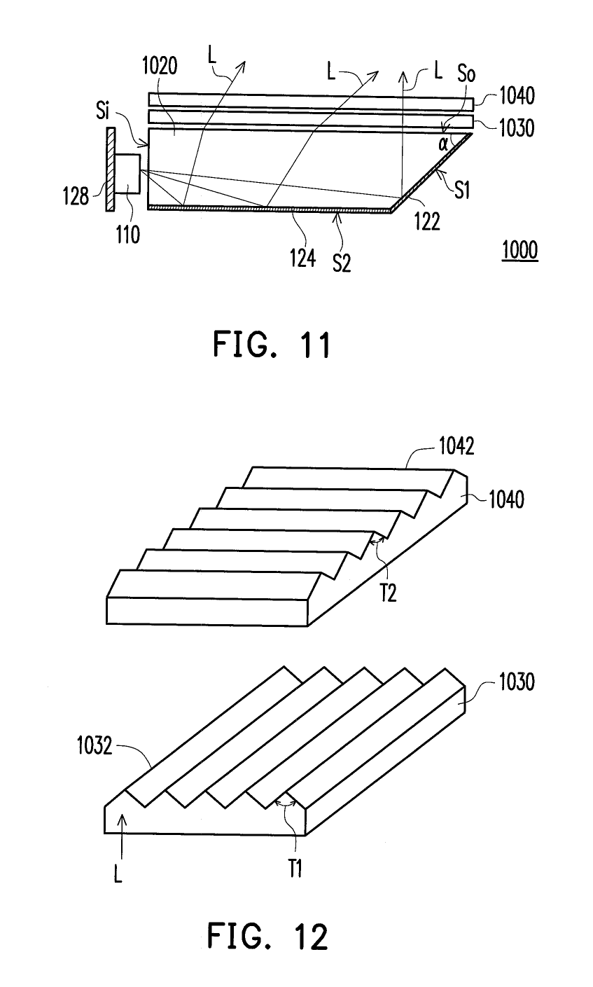

FIG. 11 is a schematic view of a light source module according to the tenth embodiment of the invention. Referring to FIG. 11, a light source module 1000 includes the light emitting element 110, a body 1020, the reflective layer 122, the reflective layer 124, a first optical film 1030 and a second optical film 1040. In the present embodiment, the light emitting element 110 can be a light emitting diode, but the invention is not limited thereto. In another embodiment, the light emitting element 110 can be a cold cathode fluorescent lamp (CCFL), or other light emitting element.

In the present invention, the first optical film 1030 and the second optical film 1040 are sequentially arranged in front of the light emitting surface So. The light source module 1000 can further include the reflective layer 128 disposed at a side of the light emitting element 110 to efficiently reflect the emitted light L of the light emitting element 110 into the body 1020 of the light guiding element to enhance the light utilization of the light source module 1000. Herein, the reflective layer 128 can be a white reflective layer.

FIG. 12 is a schematic view showing the first optical film and the second optical film of the light source module of FIG. 11. Referring to FIG. 11 and FIG. 12, the first optical film 1030 located in front of the body 1020 of the light guiding element includes, for example, a plurality of first protruding bars 1032, wherein each of the first protruding bars 1032 has a first tip angle T1. The second optical film 1040 disposed in front of the first optical film 1030 includes a plurality of second protruding bars 1042 and each of the second protruding bars 1042 has a second tip angle T2. In the present embodiment, the extension direction of the first protruding bars 1032 is perpendicular to the extension direction of the second protruding bars 1042. The first tip angle T1 and the second tip angle T2 are respectively an obtuse angle having a value of about 140 degrees to 150 degrees.

Under this design, the first optical film 1030 and the second optical film 1040 facilitate to modulate the path of the light L emitted from body 1020 of the light guiding element. In one instance, the value of the first tip angle T1 and the second tip angle T2 can be 140 degrees to 150 degrees to prevent the light L from the inner total reflection at the first tip angle T1 and the second tip angle T2. Thereby, the light emitting efficiency of the light source module 1000 can be improved. In an optical simulation, the light source module 1000 without the first optical film 1030 and the second optical film 1040 can have a light emitting distribution with a half intensity angle of about 120 degrees, in which the half intensity angle is the light emitting angle range at a half of the peak intensity. In addition, the light source module 1000 without the first optical film 1030 and the second optical film 1040 can have a Unified Glare Ratio (UGR, as recommended by the CIE) greater than 19. In compared thereto, the light source module 1000 with the first optical film 1030 and the second optical film 1040 can have a light emitting distribution with a half intensity angle of about 100 degrees and have a UGR value smaller than 19, e.g. UGR value is from 16 to 18. In other words, the configuration of the first optical film 1030 and the second optical film 1040 in front of the body 1020 of the light guiding element is conducive to modulate the light emitting distribution of the light source module 1000 and improve the glare effect, which is help to be applied in the daily like illumination application.

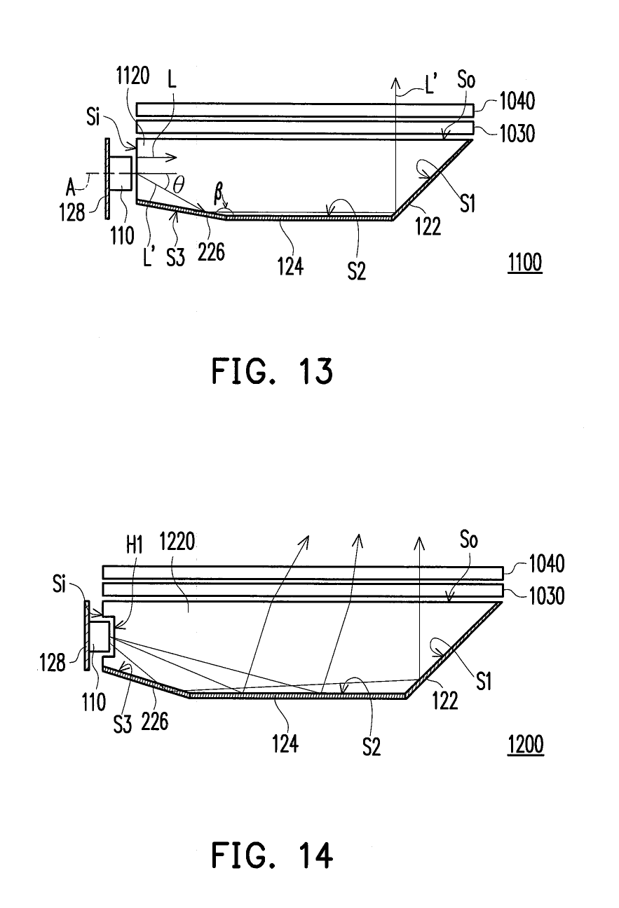

FIG. 13 is a schematic view of a light source module according to the eleventh embodiment of the invention. Referring to FIG. 13, a light source module 1100 is similar to the light source module 1000 depicted in FIG. 12. In the present embodiment, the body 1120 of the light guiding element further includes a third surface S3 connected between the light incident surface Si and the second surface S2. The third surface S3 and the second surface S2 are included by an obtuse angle β of about 165 degrees to 170 degrees. Accordingly, the third surface S3 is a slightly oblique surface arranged adjacent to the light incident surface Si. Herein, the reflective layer 226 can be selectively disposed on the third surface S3 and can be a white reflective layer.

The emitted light L of the light emitting element 110 travels mainly along the optical axis A. Nevertheless, a portion of the light, such as the light L′, may travel in the direction diverging from the optical axis A. If the light L′ travels at a large diverging angle, the light L′ can irradiate on the third surface S3. The slightly oblique third surface S3 facilitates to guide a portion of the light, i.e. the light L′, to emit from the light guiding element at where is far from the light incident surface Si so that the light emitting uniformity of the light source module 800 is improved.

FIG. 14 is a schematic view of a light source module according to the twelfth embodiment of the invention. Referring to FIG. 14, the light source module 1200 is similar to the light source module 1100. Specifically, the light source module 1200 includes a concave H1 configured at the light incident surface Si of the body 1220 of the light guiding element for accommodating the light emitting element 110. By disposing the light emitting element 110 in the concave H1 conduces to improve the incident efficiency of the emitted light into the body 1220 of the light guiding element.

It is noted that the first optical film 1030 and the second optical film 1040 is conducive to modulate the emitting effect of the light source module. Accordingly, the light source modules 400˜4000 in the above embodiments can be selectively configured with the first optical film 1030 and the second optical film 1040 in front of the light emitting surface So.

In summary, the light source module according to the invention has increased light utilization efficiency by guiding the light provided by the light emitting element to emit out from the light emitting surface through the reflective component opposite to and non-parallel to the light incident surface. In addition, the light source module according to the invention includes the reflective component opposite to the light emitting surface, such that the light provided by the light emitting element is evenly emitted from the light emitting surface, which enhances the light emitting uniformity of the light source module. The light source module according to the invention can be configured with a slightly inclined surface adjacent to the light incident surface (i.e. the third surface as mentioned in above), which conduces to introduce apportion of the light to emit out at where is farther from the light incident surface and enhance the light emitting uniformity of the light source module. In some embodiment of the invention, the light emitting surface of the light guiding element can be divided into several sections gradually inclined toward the back surface. As such, the light travelling to where is far from the light incident surface is easily emitted out, which improves the light emitting uniformity. In addition, the body of the light guiding element can have microstructures at where is far from the light emitting surface for achieving desirable light emitting effect. In an embodiment, two optical films can be arranged in front of the light emitting surface of the light source module so as to modulate the light emitting effect of the light source module. The light source module according to the embodiment of the invention can comply with the anti-glare requirement when being utilized in the illumination application.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A light source module, comprising:
a light emitting element; and
a light guiding element having:
a light incident surface, the light emitting element facing to the light incident surface;
a light emitting surface connected to the light incident surface;
a first surface connected to the light emitting surface and opposite to the light incident surface, wherein the first surface is non-parallel to the light incident surface;
a second surface connected to the first surface and opposite to the light emitting surface;
a first reflector disposed on the first surface; and
a second reflector disposed on the second surface.

2. The light source module according to claim 1, wherein an acute angle is included by the light emitting surface and the first surface.

3. The light source module according to claim 2, wherein the acute angle is from 30 degrees to 60 degrees.

4. The light source module according to claim 1, further comprising a third reflector disposed on a third surface of the light guiding element, wherein the third surface is connected between the light incident surface and the second surface and an obtuse angle is included by the third surface and the second surface.

5. The light source module according to claim 4, wherein the third surface is inclined toward the light emitting surface from an extension of the second surface so that the obtuse angle is from 165 degrees to 170 degrees.

6. The light emitting module according to claim 4, wherein the first reflector, the second reflector and the third reflector are respectively a white reflective layer.

7. The light source module according to claim 1, further comprising a fourth reflector disposed at a side of the light emitting element opposite to the light incident surface.

8. The light source module according to claim 1, wherein the light incident surface has a concave for accommodating the light emitting element.

9. The light source module according to claim 1, further comprising a supporting frame, wherein the light emitting element and the light guiding element are accommodated inside the supporting frame and the supporting frame has an opening exposing the light emitting surface of the light guiding element.

10. The light source module according to claim 9, wherein the supporting frame further has:
a first top portion covering a portion of the light emitting surface of the light guiding element; and
a second top portion opposite to the first top portion and covering another portion of the light emitting surface of the light guiding element, while the first top portion and the second top portion fix the light guiding element in the opening of the supporting frame.

11. The light source module according to claim 1, wherein the light emitting surface has a first section, a second section and a third section sequentially arranged outward from the light incident surface, the second surface is substantially parallel to the first section of the light emitting surface, the second section is substantially inclined toward the second surface from an extension of the first section by a first acute angle, the third section is substantially inclined toward the second surface from the extension of the first section by a second acute angle and the first acute angle is smaller than the second acute angle.

12. The light source module according to claim 11, wherein the first acute angle is greater than 0 degree and smaller than 5 degrees.

13. The light source module according to claim 11, wherein the second acute angle is from 6 degrees to 10 degrees.

14. The light source module according to claim 11, wherein a length of the first section is larger than a half of a length of the light guiding element.

15. The light source module according to claim 1, wherein the light guiding element further has a plurality of microstructures configured on the first surface and a portion of the light emitting surface corresponding to the first surface.

16. The light source module according to claim 1, wherein the first surface is inclined toward the light emitting surface from an extension of the second surface so that an obtuse angle included between the first surface and the second surface is from 130 degrees to 140 degrees.

17. The light source module according to claim 1, further comprising:
a first optical film disposed in front of the light emitting surface and having a plurality of first protruding bars, each of the first protruding bars having a first tip angle; and
a second optical film disposed in front of the first optical film and having a plurality of second protruding bars, each of the second protruding bars having a second tip angle, wherein the first tip angle and the second tip angle are respectively a first obtuse angle and an extension direction of the first protruding bars and an extension direction of the second protruding bars are perpendicular to each other.

18. The light source module according to claim 17, wherein the first tip angle and the second tip angle are respectively from 140 degrees to 150 degrees.

19. A light source module, comprising:
a light emitting element;
a light guiding element having:
a light incident surface, the light emitting element facing to the light incident surface;
a light emitting surface connected to the light incident surface;
a first surface connected to the light emitting surface and opposite to the light incident surface, wherein the first surface is non-parallel to the light incident surface; and
a second surface connected to the first surface and opposite to the light emitting surface; and
a supporting frame accommodating the light emitting element and the light guiding element therein, and the supporting frame comprising:
a first reflective portion parallel to the first surface;
a second reflective portion connected to the first reflective portion and parallel to the second surface; and
a third reflective portion connected to the second reflective portion and parallel to the light incident surface.

20. The light source module according to claim 19, wherein the supporting frame further has:
a first top portion covering a portion of the light emitting surface of the light guiding element; and
a second top portion opposite to the first top portion and covering another portion of the light emitting surface of the light guiding element, while the first top portion and the second top portion fix the light guiding element in the opening of the supporting frame.
